(19) United States
(12) Patent Application Publication
(10) Pub. No.: US 2026/0130561 A1
(43) Pub. Date: May 14, 2026

(54) WIPING TOOL

(71) Applicant: TYROLER LTD., Neve Yamin (IL)

(72) Inventor: Dan TYROLER, Yesod HaMa'ala (IL)

(73) Assignee: TYROLER LTD., Neve Yamin (IL)

(21) Appl. No.: 19/118,033

(22) PCT Filed: Sep. 28, 2023
(86) PCT No.: PCT/IL2023/051047

§ 371 Date: Apr. 3, 2025

(30) Foreign Application Priority Data
Oct. 6, 2022 (IL) 297142

(51) Int. Cl. A47L 13/12; A47L 1/15; A47L 13/11; A47L 13/16; A47L 13/42; B25G 3/38

(52) U.S. Cl. CPC A47L 13/12; A47L 1/15; A47L 13/11; A47L 13/16; A47L 13/42; B25G 3/38

(57) ABSTRACT

A cleaning device/tool for facilitating easier wiping manipulation over a surface to be wiped. The cleaning device can be used for wiping horizontal surfaces, such as floors, and vertical surfaces, such as windows. The cleaning device of the present disclosure comprises a wiping portion with a wiping edge that is intended to engage with a surface to be wiped. The cleaning device further comprising a surface-engaging element that is fixedly coupled to the wiping portion, namely the surface-engaging element and the wiping portion are two parts of a common structure and maintain in a constant relation between them. The cleaning device further comprising a head unit that comprises a handle receptacle for receiving an end of a handle thereto, the handle receptacle is rotatable about at least one axis.

### TECHNOLOGICAL FIELD

The present disclosure is in the field of cleaning tools, in particular cleaning tools for wiping.

### BACKGROUND ART

References considered to be relevant as background to the presently disclosed subject matter are listed below:
GB2261365
US2009049636
WO06002654

Acknowledgement of the above references herein is not to be inferred as meaning that these are in any way relevant to the patentability of the presently disclosed subject matter.

### GENERAL DESCRIPTION

The present disclosure provides a cleaning device/tool for facilitating easier wiping manipulation over a surface to be wiped. The cleaning device can be used for wiping horizontal surfaces, such as floors, and vertical surfaces, such as windows. The cleaning device of the present disclosure comprises a wiping portion with a wiping edge that is intended to engage with a surface to be wiped. The cleaning device further comprising a surface-engaging element that is fixedly coupled to the wiping portion, namely the surface-engaging element and the wiping portion are two parts of a common structure and maintain in a constant relation between them. The cleaning device further comprising a head unit that comprises a handle receptacle for receiving an end of a handle thereto, the handle receptacle is rotatable about at least one axis. The combination of the wiping portion, the surface-engaging element and the head unit on a single structure allows to form a very efficient wiper that facilitates to perform continuous wiping movements with minimum effort and with minimum experience. Furthermore, this unique structure ensures that there is a distribution of the pressure applied on the surface between the wiper element and the surface-engaging element that allows smooth movement of the cleaning device over the surface.

Thus, an aspect of the present disclosure provides a cleaning device. The cleaning device comprises a first wiper element (can be also referred to as a squeegee element), a head unit and at least one surface-engaging element. The first wiper element comprises a first wiper base elongated along a first axis and extending between first and second ends. A first wiping portion is extending from said first wiper base to a first direction. The first wiping portion has a first wiping edge for engaging a surface to be wiped. The head unit is coupled to or integral with the first wiper base and comprising either (i) a coupling portion configured to be coupled with or to receive a manipulating element, such as a manipulating arm of a car wiper or (ii) a receptacle having a bore defining a receptacle axis, typically orthogonal to the first axis, for receiving an end of a rod. The coupling or integration of the head unit to the first wiper base may be directly or indirectly, namely it can be fixedly coupled to or integral with the first wiper base through other elements. Either the receptacle or the coupling portion is configured to pivot about at least a second axis, parallel to the first axis. The at least one surface-engaging element is fixedly attached to the first wiper element and comprises a surface-engaging portion for engaging a surface such that when the engaging portion engages the surface, the first wiping portion, and in particular the first wiping edge engages the surface at a desired constant acute angle with respect to the wiping direction, namely the angle that is formed with the surface towards the direction of the surface-engaging element, which is the wiping direction that the cleaning device moves during wiping action. The pivoting capability of the receptacle allows a user to manipulate the cleaning device such that during a single wiping movement of the cleaning device over the surface to be wiped, the wiping edge smoothly remains engaged with a constant angle with the surface.

Another aspect of the present disclosure provides a cleaning device. The cleaning device comprises: a first wiper element, a head unit and at least one surface-engaging element receiving portion. The first wiper element comprises (i) a first wiper base elongated along a first axis and extending between first and second ends, and (ii) a first wiping portion extending from said first wiper base to a first direction. The first wiping portion has a first wiping edge for engaging a surface. The head unit comprises two opposite receiving bores facing one another for receiving a rod to allow pivotally coupling of a handle/rod receptacle. The at least one surface-engaging elements receiving portion is configured for receiving at least one surface-engaging element for engaging a surface such that when an engaging portion of said at least one surface-engaging element engages the surface, the first wiping portion engages the surface at a desired constant acute angle.

It is to be noted that any combination of the described embodiments with respect to any aspect of this present disclosure is applicable. In other words, any aspect of the present disclosure can be defined by any combination of the described embodiments.

In some embodiments, the cleaning device further comprising a bridging element extending from the first wiper base and said at least one surface-engaging element is coupled to or integral with the bridging element. It is to be understood that the bridging element is an element that couples the first wiper base with the at least one surface-engaging element. The bridging element is not limited to a certain shape or to the coupling locations of the first wiper base and the at least one surface-engaging element.

In some embodiments of the cleaning device, the at least one surface-engaging element is coupled to or integral with a distal end portion of the bridging element, namely the portion that is the most distal from the first wiper base.

In some embodiments of the cleaning device, the head unit is coupled or integral with the bridging element.

In some embodiments of the cleaning device, the head unit is disposed between the at least one surface-engaging element and the first wiper base.

In some embodiments of the cleaning device, the head unit is positioned on the first wiper base.

In some embodiments of the cleaning device, the head unit is positioned on the first wiping portion. This is particularly relevant when using the cleaning device such that the user always above the cleaning device and the cleaning movement is vertical.

In some embodiments of the cleaning device, the first wiper element and the at least one surface-engaging element are a single-piece molded article.

In some embodiments of the cleaning device, the first wiper element, the head unit and the at least one surface-engaging element are a single-piece molded article.

In some embodiments of the cleaning device, the first wiper element and the at least one surface-engaging element are made of an elastomeric material.

In some embodiments of the cleaning device, the first wiper base comprises a reinforcing element spanning at least a portion between said first and second ends.

In some embodiments of the cleaning device, the first wiping edge is flexible.

In some embodiments of the cleaning device, the first wiper element comprises a second wiping portion extending from said first wiping portion to a second direction. The second wiping portion is having a second wiping edge. This embodiment of the cleaning device is intended is for allowing a user of the cleaning device to wipe the end portion of a surface, specifically vertical window surface, where the surface-engaging element leads the movement, and it bumps into the floor or the frame of the window.

In some embodiments of the cleaning device, the second wiping portion forms an angle of about 90° with the first wiping portion.

In some embodiments of the cleaning device, the at least one surface-engaging element is in the form of an abutment.

In some embodiments of the cleaning device, the at least one surface-engaging element is a wheel.

In some embodiments of the cleaning device, the at least one surface-engaging element is a cleaning tool, such as a mop, a brush, a squeegee, a wiper, a sponge, etc. It is to be noted that the surface-engaging portion is constituted by portions of the cleaning tool, in particular bottom portions of the cleaning tool that are intended to be in contact with the surface to be cleaned during the cleaning process. For example, the surface-engaging portions can be the bottom portions of a mopping unit coupled to the first wiper base. The cleaning tool and the first wiper element are fixedly attached to one another or integrally formed such that they rotate and move together.

In some embodiments of the cleaning device, the at least one surface-engaging element is made of at least one of: silicone, silicone rubber and rubber.

In some embodiments of the cleaning device, the first wiper base comprises a rigid element, e.g., a metal rod, extending for at least a part of the length between the first end and the second end. The rigid element is reinforcing the base and the first wiper element structure.

In some embodiments of the cleaning device, the head unit is formed

In some embodiments of the cleaning device, said desired constant acute angle is between about 10° and about 75°. In some embodiments, the desired constant acute angle is between 15°, 20° 25°, 30°, 35° or 40° and 45°, 50°, 55°, 60°, 65°, 70°.

In some embodiments of the cleaning device, a wiping axis, or several parallel wiping axes, are defined by the geometrical distance between each of the at least one surface-engaging element and the first wiping edge. Namely, the wiping axis is defined by the normal line from the line that is defined by the first wiping edge that meets the surface-engaging portion of the surface-engaging element. A wiping direction, namely the direction of the wiping action by the user using the cleaning device, is defined along said wiping axis or wiping axes such that the surface-engaging element being the lead and the first wiping edge being trailed thereafter.

In some embodiments of the cleaning device, the head unit is disposed between the surface-engaging element and the first wiping edge along said wiping axis or an axis parallel thereto.

In some embodiments of the cleaning device, the surface-engaging element comprises a main body and a surface-engaging portion, made of a different material than the main body.

In some embodiments of the cleaning device, the surface-engaging portion is attached to the main body. In some embodiments, the surface-engaging portion can be integral to the main body. The surface-engaging portion is made of material having a low friction coefficient or to allow smooth movement over the surface. The material can be a synthetic polymer such as any type of plastic, Teflon, nylon, etc. It can also be made of organic material, such as wood.

In some embodiments of the device, the surface-engaging element comprises a first magnet member attractable to a second magnet member, thereby allowing to perform wiping of an external portion of a window by attracting the magnet from the interior side of the window and moving the cleaning device by a movement of the internal magnet over the window. In some embodiments, the second magnet member can be housed in a cleaning device, e.g. a similar cleaning device, for simultaneous clean of the two sides of the window.

In some embodiments of the cleaning device, the head unit comprises a receptacle a receptacle having a bore defining a receptacle axis for receiving an end of a rod. The receptacle is pivotable about at least a second axis, parallel to the first axis.

In some embodiments of the cleaning device, the head unit comprises a coupling portion configured to be coupled with a manipulating element. The manipulating element can be any element that is configured to manipulate the cleaning device, typically an automatically driven manipulating element, such as the metallic element that is coupled to car wipers. This renders the cleaning device to a car wiper. The coupling portion is pivotable about at least a second axis, parallel to the first axis.

In some embodiments of the cleaning device, the surface-engaging portion and the first wiping edge define a first plane, which is the plane also defined by the surface, when the cleaning device is in use. A second plane parallel to the first plane includes the first axis and a third plane parallel to the first plane includes the second axis. The second plane is positioned between the first and third planes. Thus, the pivoting part of the head unit is above the rigid element of the first wiper base, with respect to the surface to be cleaned.

In some embodiments of the cleaning device, said at least one surface-engaging element is a third wiper element extending from a third wiper base to a third direction, said third wiping portion is having a third wiping edge for engaging the surface. wherein said engaging portion is said third wiping edge, namely the engaging portion is constituted by said third wiping edge. Therefore, when a user utilizes the cleaning device and performs a wiping manipulation, there is a leading wiping edge and a trailing wiping edge. This also ensures that the wiping activity is done as two wipers move one after the other on the same portion of the surface.

In some embodiments of the cleaning device, said third direction is similar to said first direction. Namely, the planes that are defined by the first wiping portion and the third wiping portion are parallel or forming an acute angle of up to 5°, up to 10° or up to 20° therebetween.

In some embodiments of the cleaning device, the desired constant angle that the first wiping edge forms with the surface to be cleaned is about the same constant angle that the third wiping edge forms with the surface to be cleaned. Namely, the angle the that the third wiping edge forms with the surface to be cleaned is up to 5°, up to 10° or up to 20° from the angle that the first wiping edge forms with the surface to be cleaned.

In some embodiments of the cleaning device, the third wiper base is elongated along a third axis and extending between third and fourth ends.

In some embodiments of the cleaning device, the third axis and the first axis are parallel. In some embodiments, the first wiper base and the second wiper base are having similar lengths, namely, their lengths are the same or deviates up to 5%, up to 10%, or up to 20%.

In some embodiments, the cleaning device further comprises a planar base, wherein the first wiper base and the third wiper base are fixed to said planar base, wherein the head unit is coupled to the planar base and comprises a receptacle having a bore defining a receptacle axis for receiving an end of a rod, wherein said receptacle is pivotable about at least a second axis.

In some embodiments of the cleaning device, the first wiper base and the third wiper base are fixed to opposite sides of the planar base. Namely, the head unit is located between the first wiper base and the third wiper base.

In some embodiments of the cleaning device, the first wiper base is formed along a first edge portion of the planar base and the third wiper base is formed along a second edge portion of the planar base. Namely, the planar base has a first edge portion that comprises a first edge and a second edge portion that comprises a second edge, the first wiper base is formed at the first edge portion and the third wiper base is formed at the second edge portion. The first edge is located at an opposite side of the second edge.

In some embodiments of the cleaning device, the first edge is parallel to the second edge.

In some embodiments of the cleaning device, the planar base comprises two opposite bores facing one another extending along holes axis parallel to the first axis and the third axis, said two opposite bores are designed to receive an elongated rod for rotatably coupling said head unit to the planar base.

In some embodiments of the cleaning device, said planar base comprises two elongated abutments protrude from a top face thereof, said two abutments form said two opposite bores.

In some embodiments of the cleaning device, the planar base comprises a plurality of reinforcing ribs extending from said two abutments to reinforce the planar base. In some embodiments, each reinforcing rib extends from a respective abutment towards one edge of the planar base.

In some embodiments of the cleaning device, the planar base, the first wiper element and the third wiper element are formed as a single-piece molded article. Namely, these three components of the cleaning device are formed by the same mold. It is to be noted that any element that is part of the planar base, such as the abutments or the ribs, is also part of this single-piece molded article.

In some embodiments of the cleaning device, the first wiping edge and the third wiping edge are, or extend, in the same plane.

In some embodiments of the cleaning device, the first wiper base comprises a first elongated rigid element extending at least along a portion of the first wiper base to provide it additional rigidity. The third wiper base comprises a third elongated rigid element extending at least along a portion of the third wiper base to provide it additional rigidity. Therefore, the device is designed to have some flexibility between the first rigid element and the rod that is received in the bores and some flexibility between the third rigid element and the rod that is received in the bores. For example, the rigid elements can be metal rods. The first and third rigid elements can be on the same plane as the rod that is received in the bores or on a plane the is more proximal to the wiping edges than a parallel plane that includes the rod.

In some embodiments of the cleaning device, the planar base comprises a planar rigid plate. The planar rigid plate is embedded in the planar base. Typically, the planar base is molded around the planar rigid plate. The planar rigid plate is intended to provide rigidity to the entire planar base. This type of configuration is particularly relevant to use on a very planar surfaces, such as windows.

In some embodiments of the cleaning device, the planar base comprises, fixed with or formed with attaching means for attaching a cleaning cloth. The attaching means can be Velcro strips that are sewn to the planar base or slits that are formed in the planar base.

In some embodiments of the cleaning device, the first wiping edge and the third wiping edge define a wiping plane and a coupling rod coupling the head unit to the planar base define a rod plane parallel to the wiping plane. The distance between the coupling rod to any one of the first and third wiper bases is at least two-folds than the distance between the wiping plane and the rod plane, or at least 2.5 folds, at least 3 folds, at least 4 folds, or at least 5 folds. This is important to ensure the stability of the device during wiping activity.

In some embodiments of the cleaning device, the distance of the first wiper base to the head unit is equal to the distance of the third wiper base to the head unit.

Yet another aspect of the present disclosure provides a cleaning device. The cleaning device comprising a first wiper element and a head unit. The first wiper element comprises (i) a first wiper base elongated along a first axis and extending between first and second ends, and (ii) a first wiping portion extending from said first wiper base to a first direction, said first wiping portion is having a first wiping edge for engaging a surface. The head unit, directly or indirectly, is coupled to or integral with the first wiper base and comprising a receptacle with a bore defining a receptacle axis for receiving an end of a rod, wherein said receptacle is configured to pivot about at least a second axis. The first wiper element comprises a second wiping portion extending from said first wiping portion to a second direction, said second wiping portion is having a second wiping edge.

In some embodiments of the cleaning device, said second wiping portion forms an angle of about 90° with the first wiping portion.

In some embodiments of the cleaning device, the second wiping portion extends from the bottom portion of the first wiping portion.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1D are schematic illustrations of different views of a non-limiting example of the cleaning device according to the present disclosure. FIG. 1A is a perspective view; FIG. 1B is a side view; FIG. 1C is a top view; and FIG. 1D is a bottom view.

FIGS. 2A-2C are schematic illustrations of different views of another non-limiting example of an embodiment of the cleaning device according to an aspect of the present disclosure. FIG. 2A is a side view; FIG. 2B is a bottom perspective view; and FIG. 2C is a top perspective view.

FIGS. 3A-3C are schematic illustrations of the single-piece molded article of the cleaning device shown in FIGS. 2A-2C, according to an aspect of the present disclosure. FIG. 3A is a top perspective view; FIG. 3B is a bottom perspective view; and FIG. 3C is a front view.

FIGS. 4A-4C are schematic illustrations are schematic illustrations of different views of another non-limiting example of an embodiment of the cleaning device according to an aspect of the present disclosure. FIG. 4A is a side view; FIG. 4B is a top perspective view; and FIG. 4C is a top view.

FIGS. 5A-5D are schematic illustrations are schematic illustrations of different views of another non-limiting example of an embodiment of the cleaning device according to an aspect of the present disclosure. FIG. 5A is a side view; FIG. 5B is a top perspective view; FIG. 5C is a bottom perspective view; FIG. 5D is a top view.

### DETAILED DESCRIPTION

The following figures are provided to exemplify embodiments and realization of the invention of the present disclosure.

The term “about” throughout the description should be interpreted as a deviation of ±20% of the nominal value. For example, if the value is about 10, thus it should be understood to be in the range of 8-12.

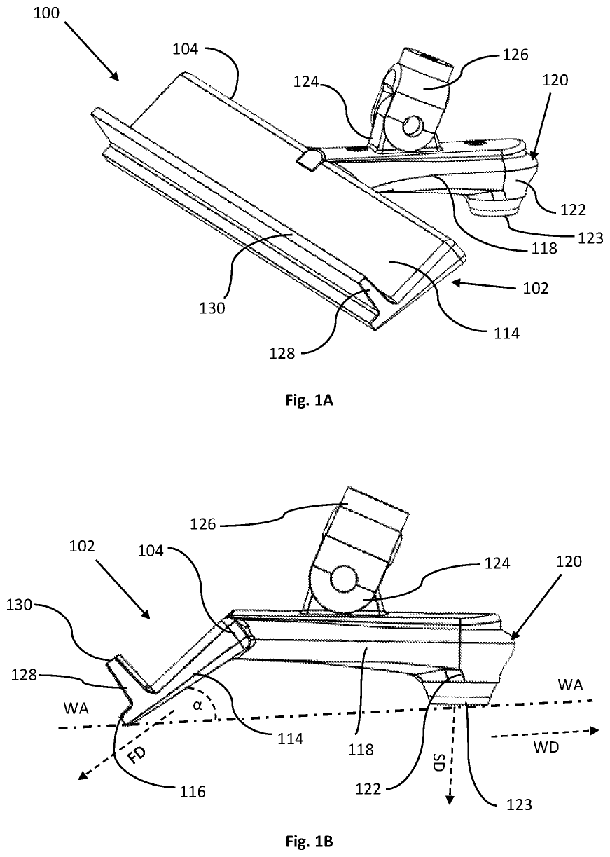

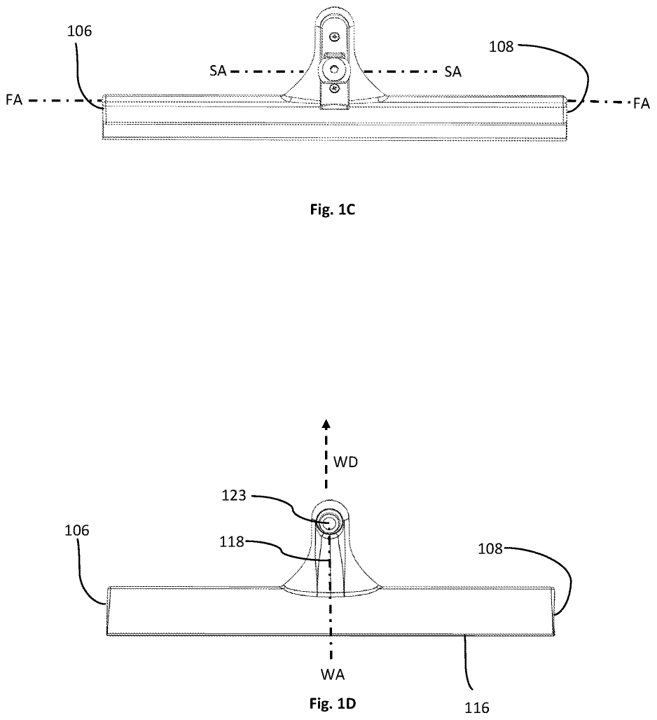

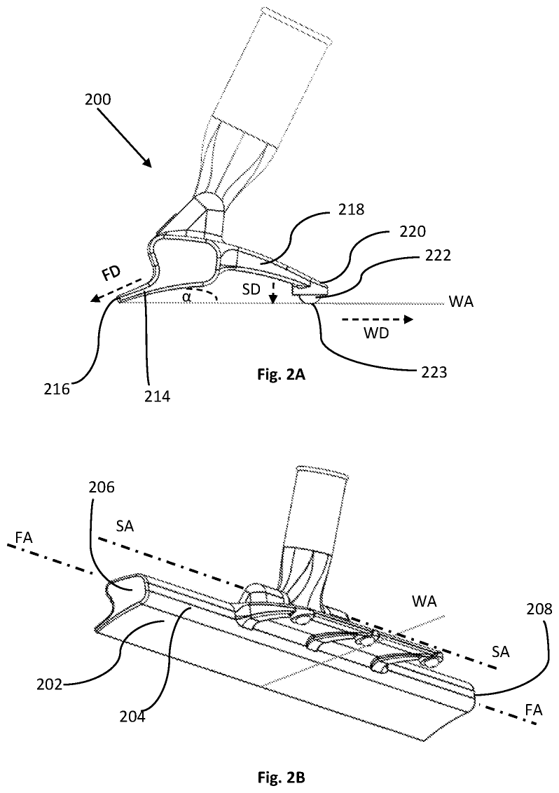

Reference is made to FIGS. 1A-1D, which are schematic illustrations of different views of a non-limiting example of the cleaning device according to the present disclosure. The cleaning device 100 comprises a wiper element 102, i.e. a squeegee element. The wiper element 102 comprises a wiper base 104, elongated along a first axis FA and extending between first and second wiper base ends 106 and 108, as can be best seen in FIGS. 1C-1D. A first wiping portion 114 extends from the wiper base 104 towards a first direction FD, orthogonal to the first axis FA. The first wiping portion 114 is tapered and has a wiping edge 116 that is configured to engage the surface to be cleaned, the first wiping portion 114 and the wiping edge 116 are flexible, thus upon application of force on the first wiping portion 114, it bends to allow efficient wiping of the surface. A bridging element 118 extends between the wiper base 104 and a distal end 120 thereof, distal from the wiper base 104. A surface-engaging element 122 is formed at the distal end portion 120. The surface-engaging element 122 is constituted by a protrusion at the end portion 120 of the bridging element that protrudes in a second direction SD, having at least a component in a similar direction to the first direction FD, namely ±90° from the first direction FD. The surface-engaging element comprises a surface-engaging portion 123 that is configured to engage with the surface to be wiped, the surface-engaging portion 123 can be made from different material(s) than other parts of the surface-engaging element 122. This design is made so as to ensure that during utilization of the cleaning device, both wiping edge 116 and the surface-engaging element 122 are engaging the surface to be cleaned simultaneously such that the angle of engagement of the wiping edge 116 with the surface remains constant. The surface-engaging element 122 can be made of plastic, rubber, silicon-rubber, silicon, thermosetting material, or elastomer. A head unit 124 is disposed on the bridging element 118 between the wiper base 104 and protrudes from the bridging element to a generally opposite direction than the surface-engaging element 122. The head unit 124 may be coupled to, attached to or integrally formed with the bridging element 118. The head unit 124 comprises a handle receptacle 126 configured to receive a handle/a rod thereinto so as to allow a user to manipulate the cleaning device and use it through the handle for cleaning. The handle receptacle 126 is pivotable about at least a second axis SA parallel to the first axis FA, thereby allowing a user to rotate the handle receptacle 126 along a range of rotational states. This allows the user to perform, through a handle received in the handle receptacle 126, a cleaning movement with the cleaning device between two spots of a surface to be wiped, wherein during all the cleaning movement the wiping edge remains engaged with the surface to be wiped at a constant angle, which is designed to be optimal for wiping. In the case of wiping vertical surfaces such as windows, the cleaning process become much easier as the design of the cleaning device allows the user to remain generally at a constant standing position while wiping from a top portion of the window to a bottom portion thereof. This is unlike the use of standard wipers or squeegees that require the user to bend for the end of the cleaning process and/or to carefully change the intensity of the force application with the wiper against the window to achieve the desired wiping result.

A wiping axis WA is defined by the geometrical distance line extending between the surface-engaging portion 123 and the wiping edge 116. A wiping direction WD is defined along said wiping axis WA, such that the surface-engaging element 122 is leading the movement over the surface to be wiped and the first wiping edge 116 is trailed after the surface-engaging element 122 over the surface to be wiped.

The constant angle a that the first wiping portion 114 forms with the surface is exemplified in FIG. 1B. This constant angle α is an acute angle to the wiping direction WD and is between about 20° and about 65°.

Furthermore, in this non-limiting embodiment, the cleaning device 100 further comprising a second wiping portion 128 extending from a distal portion of the first wiping portion 114 such that the planes defined by the first wiping portion 114 and the second wiping portion 128 forms an angle of about 90° therebetween. The second wiping portion 128 is tapered and has a wiping edge 130. The second wiping portion 128 extend to a smaller extent than that of the first wiping portion 114. The second wiping portion 128 is particularly relevant for cleaning windows such that when the cleaning device reaches the frame of the window when the surface-engaging element leads the movement, the surface portion that remains unwiped between the surface-engaging element 122 and the wiping edge 116, is then can be wiped by the second wiping edge 130.

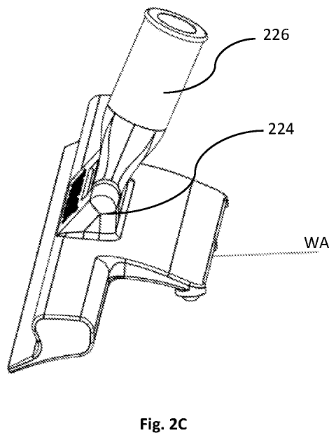

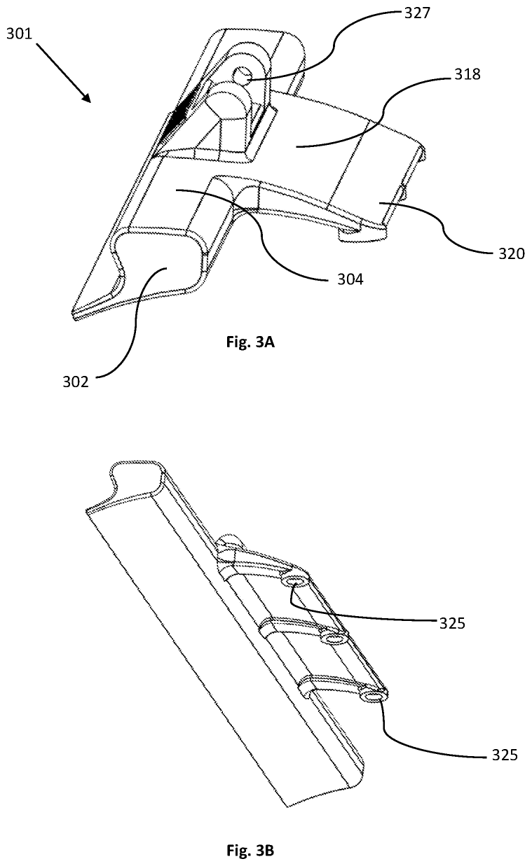

In the figures throughout the application, like elements of different figures were given similar reference numerals shifted by the number of hundreds corresponding to the number of the respective figure. For example, element 202 in FIGS. 2A-2C serves the same function as element 102 in FIGS. 1A-1D.

Reference is now being made to FIGS. 2A-2C, which are schematic illustrations of another non-limiting example of an embodiment of the cleaning device according to an aspect of the present disclosure. The cleaning device 200 comprises a wiper element 202 that comprises a wiper base 204, elongated along a first axis FA and extending between first and second wiper base ends 206 and 208. A first wiping portion 214 extends from the wiper base 204 towards a first direction FD, orthogonal to the first axis FA. The first wiping portion 214 is tapered and has a wiping edge 216 that is configured to engage the surface to be cleaned. The first wiping portion 214 and the wiping edge 216 are flexible, thus upon application of force on the first wiping portion 214, it bends to allow efficient wiping of the surface. A bridging portion 218 extends between the wiper base 204 and a distal end 220 thereof, distal from the wiper base 204. In this non-limiting example, the bridging portion 218 is curved but it is to be noted that the bridging element may have different shapes. Three surface-engaging elements 222 are formed at the distal end portion 220 and are constituted by protrusions at the end portion 220 of the bridging portion 218 that protrude in a second direction SD, having at least a component in a similar direction to the first direction FD (i.e. a component in the direction to the intended surface to be cleaned), namely ±90° from the first direction FD. Each of the surface-engaging elements 222 comprises a surface-engaging portion 223 that is configured to engage with the surface to be wiped, the surface-engaging portions 223 can be made from different material(s) than other parts of the surface-engaging elements 222. The surface-engaging elements 222 can be made of plastic, rubber, silicon-rubber, silicon, thermosetting material, or elastomer. It is essential that the tips of the surface-engaging elements 222, namely the tips of the surface-engaging portions 223, are disposed on a single plane or in some specific examples such as in this example, on a single axis. This ensures that they all engage simultaneously with the surface to be cleaned. It is to be noted that during utilization of the cleaning device, only the wiping edge 216 and the surface-engaging elements 222 are intended to be engaged with the surface to be cleaned, thereby maintaining a constant attacking angle of the wiping edge with the surface for the entire wiping manipulation of the user. A head unit 224 formed on the wiper base 204, the head unit 224 may be coupled to, attached to or integrally formed with the wiper base 204. The head unit 224 comprises a handle receptacle 226 configured to receive a handle/a rod thereinto so as to allow a user to manipulate the cleaning device and use it through the handle for cleaning. The handle receptacle 226 is pivotable about at least a second axis SA parallel to the first axis FA, thereby allowing a user to rotate the handle receptacle 226 along a range of rotational states. This allows the user to perform, through a handle received in the handle receptacle 226, a wiping manipulation with the cleaning device between two spots of a surface to be wiped, wherein during all the cleaning movement the wiping edge remains engaged with the surface to be wiped at a constant angle, which is designed to be optimal for wiping.

Parallel wiping axes WA are defined by the geometrical distance line extending between each of the surface-engaging portion 223 and the wiping edge 216. A wiping direction WD is defined along each of said wiping axes WA, such that the surface-engaging element 222 is leading the movement over the surface to be wiped and the first wiping edge 216 is trailed after the surface-engaging elements 222 over the surface to be wiped.

The constant angle α that the first wiping portion 214 forms with the surface is exemplified in FIG. 2A. This constant angle α is an acute angle to the wiping direction WD and is between about 10° and about 75°.

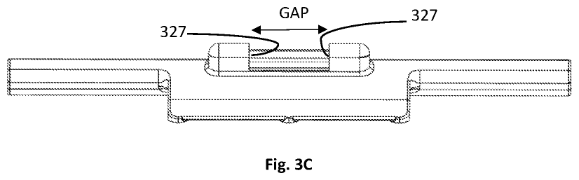

FIGS. 3A-3B are schematic illustrations of the single-piece molded article of the cleaning device shown in FIGS. 2A-2C, according to an aspect of the present disclosure. The single-piece molded article 301 comprises the wiper element 302, wiper base 304 and bridging portion 318 similar to that of cleaning device of FIGS. 2A-2C. The bridging portion end portion 320 is formed with surface-engaging elements receiving portions 325 designed to receive the surface engaging elements. Furthermore, the head unit 324 merely comprises a protrusion formed on the wiper base 304 that comprises two opposite receiving bores 327 spanning a gap GAP therebetween. The receiving bores 327 are intended to receive the rod pivotally coupling the handle receptacle to the head unit. The head unit is intended to be positioned in the gap spanned between the two receiving bores 327.

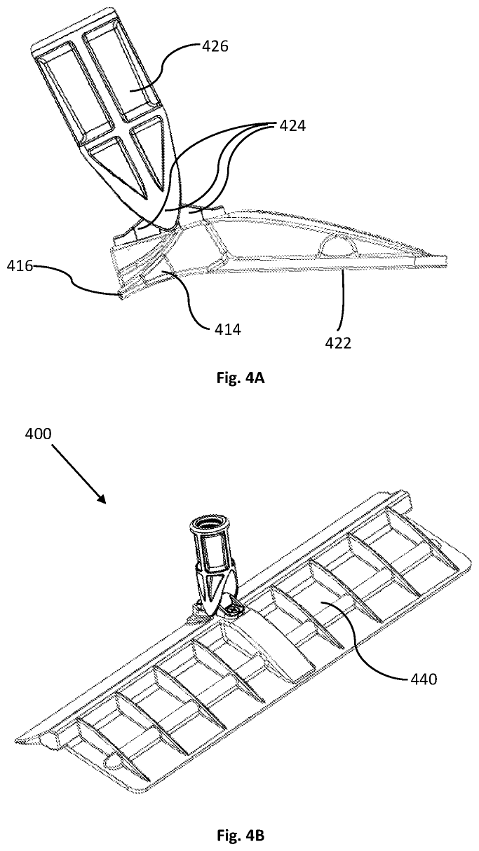

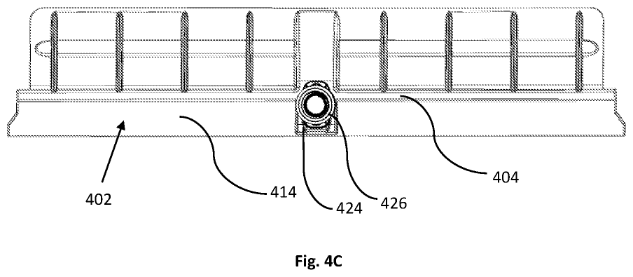

Reference is now being made to FIGS. 4A-4C, which are schematic illustrations of different views of another non-limiting example of an embodiment of the cleaning device according to an aspect of the present disclosure. The cleaning device 400 of this example differs from that shown in FIGS. 2A-2C by that the surface-engaging element 422 is constituted by a bottom face portions of a mopping unit 440. The cleaning device 400 is designed such that when the bottom face 422 of the mopping unit 440 engages the surface to be cleaned, the wiping edge 416 of the wiping portion 414 engages the surface to be cleaned in the desired constant angle. Furthermore, in this example, the mopping unit 440 extends form the wiper base 404 and therefore the cleaning device 400 does not include a discerned bridging portion (though, in some embodiments, the mopping unit can be coupled to the wiper base via a bridging portion). The mopping unit 440 and the wiper element 402 are fixedly attached to one another or integrally formed. The head unit 424 is formed partly on the wiper base 404 and partly on the wiping portion 414, namely protrudes from both the wiper base 404 and the wiping portion 414. The handle receptacle 426 itself and its pivoting capabilities are similar to that described with respect to FIGS. 2A-2C.

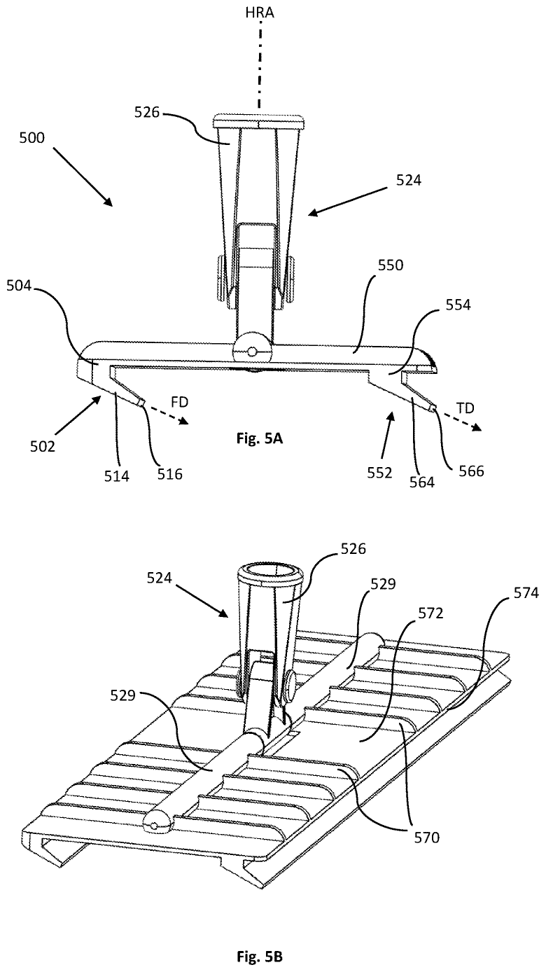

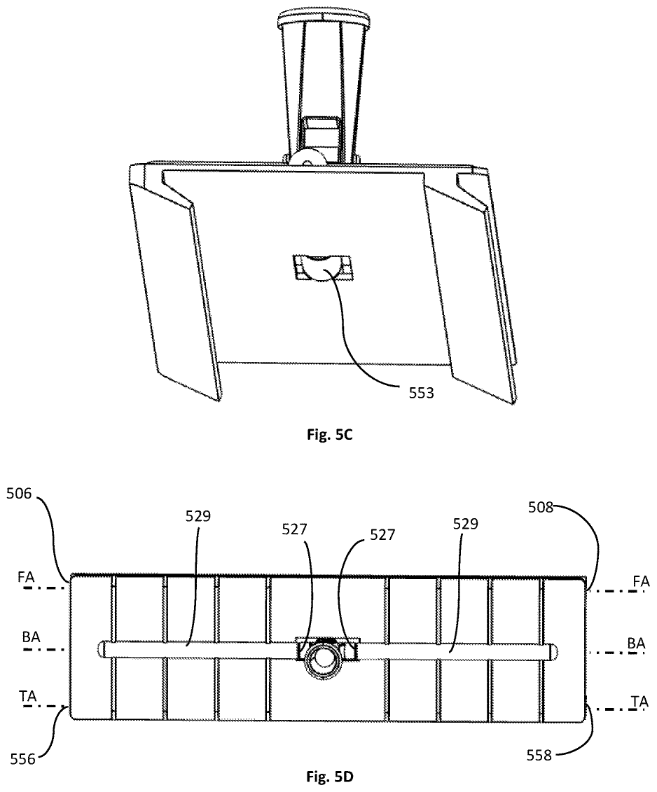

Reference is now being made to FIGS. 5A-5D, which are schematic illustrations of different views of a non-limiting embodiment of the cleaning device of the present disclosure. The cleaning device 500 comprises a planar base 550 that is integral with a first wiper element 502, i.e. a squeegee element and a third wiper element 552. The first wiper element 502 comprises a first wiper base 504, elongated along a first axis FA and extending between first and second first wiper base ends 506 and 508, as can be best seen in FIG. 5D. A first wiping portion 514 extends from the first wiper base 504 towards a first direction FD, orthogonal to the first axis FA. The first wiping portion 514 is tapered and has a first wiping edge 516 that is configured to engage the surface to be cleaned, the first wiping portion 514 and the wiping edge 516 are flexible, thus upon application of force on the first wiping portion 514, it bends to allow efficient wiping of the surface.

The second wiper element 552 comprises a second wiper base 554, elongated along a third axis TA and extending between first and second third wiper base ends 556 and 558, as can be best seen in FIG. 5D. A third wiping portion 564 extends from the first wiper base 554 towards a third direction TD, orthogonal to the third axis TA. The third wiping portion 564 is tapered and has a third wiping edge 566 that is configured to engage the surface to be cleaned, the third wiping portion 564 and the wiping edge 566 are flexible, thus upon application of force on the third wiping portion 564, it bends to allow efficient wiping of the surface. The configuration of the cleaning device 500 in this embodiment ensures that the first wiping edge 516 and the third wiping edge 566 engage the surface to be cleaned with a constant desired angle as they both extend along lines that are found in the same plane. In this embodiment, the first wiping portion 514 and the third wiping portion 564 are designed to form the same angle with surface to be cleaned (with a tolerance of up to 10°), though it is to be noted that the angles that each of them form with the surface may be different than the other. The planar base 550 comprises two opposite bores 527 facing one another for receiving a rod that allows rotatably coupling a head unit 524 to the planar base 550 via a coupling portion 553 thereof. The bores 527 extend along a bores axis BA and are formed by two respective abutments 529 that protrude from the planar base 550. By coupling the head unit 524 to the planar base 550 by a rod that is received in the bores 527, the head unit 524 is rotatable at least about the bores axis BA. The head unit 524 comprises a handle receptacle 526 configured to receive a handle/a rod thereinto so as to allow a user to manipulate the cleaning device and use it through the handle for cleaning. The handle receptacle 526 is pivotable about a handle receptacle axis HRA orthogonal to the bores axis BA. Reinforcing ribs 570 are formed on the top face 572 of the planar base 550, each extends between one of the abutments and one of the edges 574 of the planar base 550. The first wiper base 504 and the second wiper base 554 are formed on different sides of the abutments 529, and therefore on different sides of the head unit 524. The first wiping element 502, the second wiping element 552 and the planar base 550 may be all be a single-piece molded article, namely all of these components are made by a single mold. The abutments 529 are planned to be molded around the rod so as to allow the coupling of the head unit 524 to the planar base 550.

1-43. (canceled)

44. A cleaning device, comprising:
a first wiper element, a head unit and at least one surface-engaging element;
the first wiper element comprises
a first wiper base elongated along a first axis and extending between first and second ends, and
a first wiping portion extending from said first wiper base to a first direction, said first wiping portion is having a first wiping edge for engaging a surface;
the head unit, directly or indirectly, coupled to or integral with the first wiper base and comprising either (i) a coupling portion configured to be coupled with a manipulating element or (ii) a receptacle having a bore defining a receptacle axis for receiving an end of a rod, wherein either said coupling portion or said receptacle is pivotable about at least a second axis;
said at least one surface-engaging element is fixedly attached to said wiper element and comprises an engaging portion for engaging a surface such that when the engaging portion engages the surface, the first wiping portion engages the surface at a selected constant acute angle;
wherein a wiping axis is defined by the geometrical distance between the at least one surface-engaging element and the first wiping edge, wherein a wiping direction is defined along said wiping axis such that the surface-engaging element being the lead and the first wiping edge is trailed thereafter;
wherein said desired constant angle is defined with respect to the wiping direction.

45. The cleaning device of claim 44, wherein said at least one surface-engaging element is a third wiper element extending from a third wiper base to a third direction, said third wiping portion is having a third wiping edge for engaging the surface, wherein said engaging portion is said third wiping edge.

46. The cleaning device of claim 45, wherein said third direction is similar to said first direction.

47. The cleaning device of claim 45, wherein the third wiper base is elongated along a third axis and extending between third and fourth ends.

48. The cleaning device of claim 47, wherein the third axis and the first axis are parallel.

49. The cleaning device of claim 45, comprising a planar base, wherein the first wiper base and the third wiper base are fixed to said planar base, wherein the head unit is coupled to the planar base and comprises a receptacle having a bore defining a receptacle axis for receiving an end of a rod, wherein said receptacle is pivotable about at least a second axis; wherein the first wiper base and the third wiper base are fixed to opposite sides of the planar base.

50. The cleaning device of claim 49, wherein the planar base comprises two opposite bores facing one another extending along holes axis parallel to the first axis and the third axis, said two opposite bores are designed to receive an elongated rod for rotatably coupling said head unit to the planar base; wherein said planar base comprises two elongated abutments protrude from a top face thereof, said two abutments form said two opposite bores; wherein the planar base comprises a plurality of reinforcing ribs extending from said two abutments to reinforce the planar base.

51. The cleaning device of claim 49, wherein the planar base, the first wiper element and the third wiper element are formed as a single-piece molded article.

52. The cleaning device of claim 45, wherein the first wiping edge and the third wiping edge are in the same plane.

53. The cleaning device of claim 45, wherein the first wiper base comprises a first elongated rigid element extending at least along a portion of the first wiper base; wherein the third wiper base comprises a third elongated rigid element extending at least along a portion of the third wiper base;

54. The cleaning device of claim 45, wherein the planar base comprises a planar rigid plate; wherein the planar base comprises, fixed with or formed with attaching means for attaching a cleaning cloth.

55. The cleaning device of claim 45, wherein the first wiping edge and the third wiping edge define a wiping plane and a coupling rod coupling the head unit to the planar base define a rod plane parallel to the wiping plane; wherein the distance between the coupling rod to any one of the first and third wiper bases is at least two-folds than the distance between the wiping plane and the rod plane.

56. The cleaning device of claim 45, wherein the distance of the first wiper base to the head unit is equal to the distance of the third wiper base to the head unit.

57. The cleaning device of claim comprising a bridging element extending from the first wiper base and said at least one surface-engaging element is coupled to or integral with the bridging element.

58. The cleaning device of claim 57, wherein the at least one surface-engaging element is coupled to or integral with a distal end portion of the bridging element; wherein said head unit is coupled or integral with the bridging element; wherein the head unit is disposed between the at least one surface-engaging element and the first wiper base.

59. The cleaning device of claim 44, wherein the at least one surface-engaging element is either: (i) in the form of an abutment, (ii) a wheel, or (iii) a cleaning tool.

60. The cleaning device of claim 44, wherein the at least one surface-engaging element is made of at least one of: silicone, silicone rubber and rubber; or wherein said desired constant acute angle is between about 20° and about 60°.

61. The cleaning device of claim wherein the head unit comprises a receptacle having a bore defining a receptacle axis for receiving an end of a rod, wherein said receptacle is pivotable about at least a second axis.

62. The cleaning device of claim 44, wherein said head unit comprises a coupling portion configured to be coupled with a manipulating element, wherein said coupling portion is pivotable about at least a second axis.

63. The cleaning device of claim 44, wherein the surface-engaging portion and the first wiping edge define a first plane, a second plane parallel to the first plane comprises the first axis and a third plane parallel to the first plane comprises the second axis, wherein the second plane is positioned between the first and third planes.
